(19) United States
(12) Patent Application Publication
(10) Pub. No.: US 2023/0408983 A1
(43) Pub. Date: Dec. 21, 2023

(54) SMART CASE BACK FOR WRISTWATCH CASE

(71) Applicant: Rewary GmbH, Monthey (CH)

(72) Inventor: Anthony Lopez, Monthey (CH)

(21) Appl. No.: 18/037,470

(22) PCT Filed: Nov. 24, 2021
(86) PCT No.: PCT/IB2021/060916

§ 371 Date: May 17, 2023

(30) Foreign Application Priority Data
Nov. 26, 2020 (CH) 01504/20

(51) Int. Cl. G04G 21/02; G04G 17/04; G04G 17/08; G04C 10/00; G04B 43/00; G04B 47/06

(52) U.S. Cl. CPC G04G 21/025; G04G 17/04; G04G 17/08; G04C 10/00; G04B 43/00; G04B 47/063

(57) ABSTRACT

An electronic device for a wristwatch including an electronic module provided with at least one sensor capable of measuring physiological data of a wearer of the wristwatch, and with an electronic control unit associated with the sensor. The electronic device includes a trim element acting as a case back and capable of being removably mounted on a case of the wristwatch, the electronic module being integrally housed within the trim element acting as case back. In one aspect, a wristwatch includes a case having a removable case back and a horological movement housed within the case, with the removable case back constituting the electronic device.

### TECHNICAL FIELD

The present invention generally relates to an electronic device for a wristwatch, as well as to a wristwatch comprising such an electronic device.

### PRIOR ART

So-called smart or connected wristwatches—often referred to as “smartwatches”—are known from the state of the art. In this context, one distinguishes primarily two categories of wristwatches, namely those essentially electronic timepieces that basically consist of an electronic apparatus having the shape and appearance of a wristwatch (the most notable examples being the smartwatches marketed by players in the telecommunications field, such as Apple, Google and Samsung) and so-called “hybrid” timepieces that combine a conventional horological movement (usually mechanical or quartz) with one or more electronic modules providing the wristwatch with the functionalities of a smart or connected watch (which timepieces are most commonly marketed by players in the watchmaking field). The present invention falls more particularly in this second category.

Swiss patent application No. CH 713 374 A2 and corresponding international (PCT) application WO 2018/134191 A1 disclose a hybrid timepiece comprising a horological movement which drives, in a conventional way, first analog display means that provide an indication of the time, and communication means for communicating with a third-party electronic apparatus. This timepiece is more particularly marketed by company Conex Watches SA in the form of a wristwatch having the designation “X-ONE® H1” (see https://xonewatches.com/). This timepiece is in particular characterized in that it comprises a programmable electronic microcontroller comprising wireless communication means for communicating with a third-party apparatus of a smartphone type, and second analog display means, kinematically independent of the horological movement and controlled by the electronic microcontroller so as to display information received from the third-party apparatus independently of the first analog display means. In a preferred embodiment, the timepiece comprises a case within which are housed the horological movement, the first and second analog display means, as well as a removable electronic module comprising said programmable electronic microcontroller and said wireless communication means (along with a battery). The removable electronic module is housed within the case in such a way that the programmable electronic microcontroller is connected to the second analog display means via disconnectable connectors. Preferably, the removable electronic module is placed on an inner face of the horological movement so that it can be disconnected and disassembled from the horological movement from the case back, after removal of the case back. The removable electronic module can thus be replaced relatively easily, particularly if an electronic component becomes faulty or obsolete. This solution however de facto requires specific interconnection between the removable electronic module and the second electronic display means, as well as a dedicated accommodating space inside the case. Moreover, the aforementioned timepiece is de facto devoid of any physiological data sensors (such as optical heart rate sensors, or “cardio-optical” sensors), thus rendering this timepiece less attractive than competing products equipped with such sensors. A solution which is simpler and also has more functionalities is thus desirable.

Swiss patent application No. CH 715 761 A2 and corresponding European patent application EP 3 683 633 A1 disclose a hybrid timepiece, particularly a wristwatch, comprising amongst other things, housed within a case of the timepiece, a mechanical horological movement comprising a mechanical oscillator, a device for measuring operation of the mechanical oscillator, a mechanism for regulating operation of the mechanical oscillator, and a wireless communication module capable of exchanging data with the device for measuring operation of the mechanical oscillator. The wireless communication module is designed to communicate with an external electronic unit in order to transmit thereto results of the measurements made by the device for measuring operation of the mechanical oscillator, to the attention of a user. It is thus to be understood that the essential function of the wireless communication module is to communicate the results of the measurements made by the device for measuring operation of the mechanical oscillator. Although it is mentioned that the wireless communication module forms part of an electronic module that may have a large number of additional functionalities, such additional functionalities are not specified and the electronic module in question is neither detailed nor illustrated.

Swiss patent application No. CH 714 294 A2 discloses a hybrid wristwatch comprising a mechanical horological movement housed within a watch case containing no electronic components, the watch case being mounted movably on a stretcher and arranged so that it can be fixedly positioned in at least one service position, the wristwatch being characterized in that the stretcher comprises an electronic module and in that the electronic module comprises at least one sensor capable of collecting information about the wearer of the watch and/or the mechanical movement. In an embodiment variant, the stretcher also comprises on its upper face, usually masked by the watch case, an electronic display, such as a touch screen arranged to act as a user interface. The aforementioned electronic module is not specifically designed to be removable so as to be withdrawn from the stretcher, and, on the contrary, the stretcher as a whole, including the electronic module, has to be replaced if an electronic component becomes faulty or obsolete. This solution is therefore solely intended for, and applicable to, a specific type of wristwatch, namely a wristwatch comprising a stretcher and a watch case mounted movably on said stretcher.

Company Manufacture Modules Technologies SA (“MMT”—https://mmt.ch/) also markets various types of electronic quartz movements incorporating the functionality of connected or smart watches, which modules in particular equip the wristwatches marketed by Alpine Watch International SA under the designations “AlpinerX Alive®” and “AlpinerX Comtesse® Glacier”. However, these are timepieces in which the electronic module forms an integral part of the movement and is therefore not removable, and certainly not replaceable independently of the other components of the movement.

There accordingly remains a need for a solution enabling a wristwatch to be provided with the functionalities of a smartwatch without compromising its esthetics, its ergonomics in use, its lifetime, its maintainability, and/or operation of the horological movement of the wristwatch.

### SUMMARY OF THE INVENTION

One aim of the present invention is to provide an electronic device that can be fitted to a wristwatch having a horological movement in order to provide it with part or all of the functionalities of a smartwatch, in particular the ability to measure physiological data of the wearer of the wristwatch.

Another aim of the present invention is to provide such an electronic device that needs no particular adaptations of the wristwatch that is to be fitted with said electronic device.

Yet another aim of the present invention is to provide such an electronic device that has very little or no effect on the overall esthetics of the wristwatch.

An additional aim is to provide such an electronic device that is reasonably simple and relatively inexpensive to produce.

The present invention achieves these aims by providing an electronic device for a wristwatch comprising an electronic module provided with at least one sensor capable of measuring physiological data of a wearer of the wristwatch and with an electronic control unit associated with said sensor. The electronic device according to the invention comprises a trim element acting as a case back that can be mounted removably on a case of the wristwatch. Furthermore, the electronic module is integrally housed in said trim element acting as case back.

The invention thus enables a wristwatch that is conventionally provided with a removable case back to be fitted by simple replacement of the removable case back with the electronic device according to the invention, no particular modification or adaptation of the wristwatch being required apart from the replacement of said removable case back.

According to one embodiment of the invention, the trim element acting as case back itself comprises securing means for securement to the wristwatch case. In this context, the trim element acting as case back may in particular advantageously take the form of a case back that can be screwed onto the wristwatch case. In one variant, the trim element acting as case back could alternatively be secured to the case by dedicated fixing means, such as a set of screws.

The sensor capable of measuring physiological data of the wearer of the wristwatch may in particular be an optical heart rate sensor, such as a light-sensitive photodiode, in which case the trim element acting as case back is provided, on an outer face intended to be positioned in contact with the wearer's wrist, with at least a first window positioned facing the optical heart rate sensor.

In this latter context, the electronic module may also comprise at least one light source, such as a light-emitting diode, associated with the optical heart rate sensor, in which case the trim element acting as case back is provided, on its outer face, with at least a second window positioned facing the light source.

According to an advantageous embodiment variant, the electronic module further comprises a wireless communication unit, particularly a communication unit operating according to the Bluetooth standard, capable of communicating wirelessly with a third-party electronic device, such as a smartphone.

Preferably, the electronic module further comprises an additional sensor capable of detecting an action by the wearer on the wristwatch when the latter is worn on the wrist. This may in particular be a sensor coupled to the trim element acting as case back, such as a force or pressure sensor, for detecting a strain transmitted to the trim element acting as case back in reaction to a pressure exerted by the wearer on a front part of the wristwatch, such as a glass or a bezel.

The electronic module may also advantageously comprise a battery, particularly a rechargeable battery. In the latter case, the electronic device may also comprise a connector to enable an electrical connection to be established to an external charger device for recharging the battery.

Preferably, all of the electronic components of the electronic module are mounted on a single printed circuit board.

Finally, the electronic device may also comprise a partitioning element arranged so as to be interposed between the electronic module and a horological movement housed within the case of the wristwatch, once the trim element acting as case back is mounted on said case. This partitioning element may in particular act as a shielding element to reduce any interference of the electronic module with operation of the horological movement.

The electronic device according to the invention may also advantageously implement a tracking and geolocating function, enabling the electronic device to be retrieved if lost or stolen.

Also claimed is a wristwatch comprising a case including a removable case back and a horological movement housed within said case, the removable case back consisting of an electronic device according to the invention.

Further aspects and advantages of the invention are described in the remainder of the present description.

### BRIEF DESCRIPTION OF THE DRAWINGS

Features and advantages of the present invention will become more readily apparent from reading the following detailed description of embodiments of the invention, which are presented solely as non-limiting examples and are illustrated by the appended drawings, in which:

FIG. 1 is a perspective view of a wristwatch, seen from the wrist side, equipped with a removable case back consisting of an electronic device according to one embodiment of the invention;

FIG. 2 is a partial longitudinal cross-sectional view of the wristwatch of FIG. 1, taken along a vertical sectional plane passing through the 12 o'clock-6 o'clock axis of the wristwatch;

FIG. 3 is a perspective view of the electronic device, shown separately, fitted to the wristwatch of FIG. 1, which electronic device comprises in particular a trim element acting as a case back, inside which an electronic module is housed;

FIG. 4 is a perspective view of the electronic device of FIG. 3, taken from another viewing angle, from the side intended to be secured to the case of the wristwatch, facing the horological movement;

FIG. 5A is a perspective view of a transversal cross-section through the electronic device of FIG. 3, taken along a vertical sectional plane passing through the 9 o'clock-3 o'clock axis of the electronic device;

FIG. 5B is a perspective view of a longitudinal cross-section through the electronic device of FIG. 3, taken along a vertical sectional plane passing through the 12 o'clock-6 o'clock axis of the electronic device; and

FIG. 5C is a partial perspective view of the electronic device of FIG. 3, part of the trim element acting as case back being omitted in order to reveal the electronic module housed thereinside.

### EMBODIMENTS OF THE INVENTION

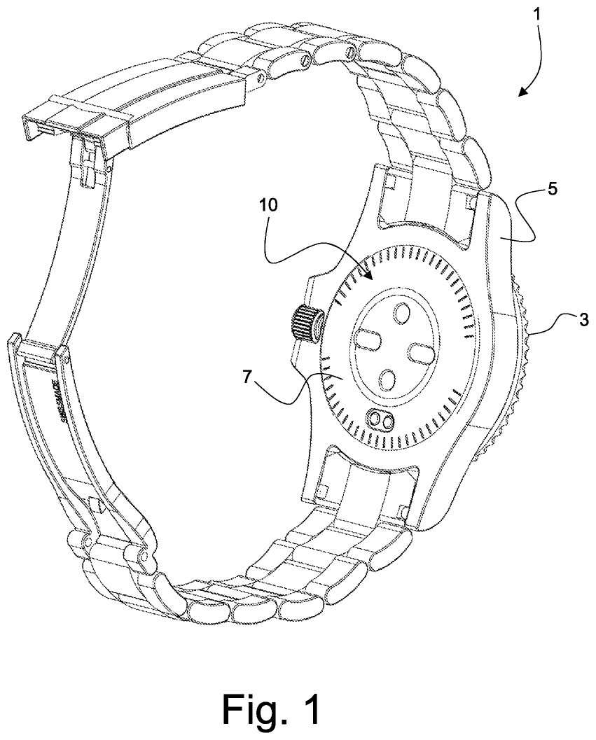

The present invention will be described with reference to various preferred embodiments, as illustrated in particular by FIGS. 1 to 5A-C.

FIG. 1 is a perspective view of a wristwatch, designated generally by reference numeral 1, equipped with an electronic device 10 according to one embodiment of the invention. The wristwatch 1 comprises, in a conventional manner, a case 5, comprising amongst other things a removable case back 7, as well as a horological movement (not visible in FIG. 1) housed inside the case 5. The removable case back 7 is in fact formed by the electronic device 10 and here advantageously takes the form of a case back screwed onto the case 5, as is conventionally seen in many commercially available wristwatches.

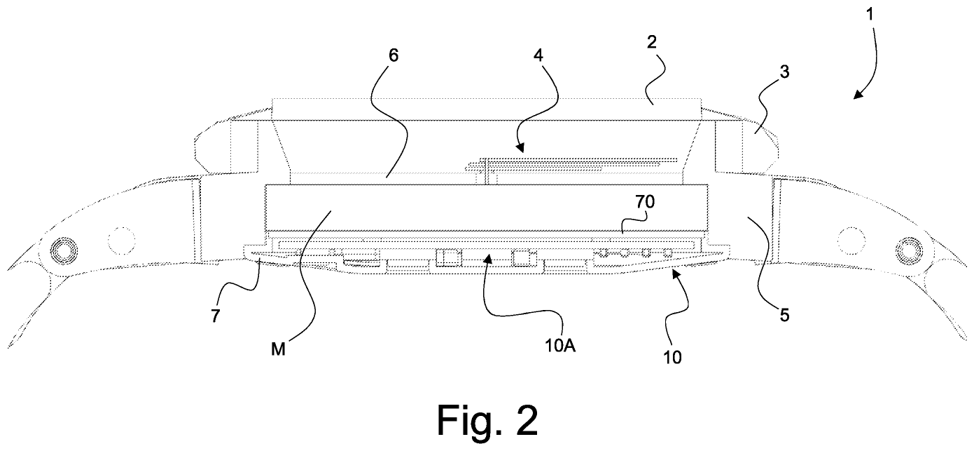

The longitudinal cross-sectional view of FIG. 2, taken along a vertical sectional plane passing through the 12 o'clock-6 o'clock axis of the wristwatch of FIG. 1, reveals the presence of the horological movement M housed inside the case 5. The horological movement M is conventionally positioned below a dial 6 and drives an analog time display mechanism 4 which conventionally comprises a set of hands driven into rotation by the horological movement M. Reference numerals 2 and 3 denote, respectively, a glass and a bezel, possibly rotatable, mounted on the case 5.

The electronic device 10 is also visible in FIG. 2, which electronic device 10 comprises an electronic module 10A that—as described below—is in particular provided with at least one sensor capable of measuring physiological data of a wearer of the wristwatch 1 and with an electronic control unit associated with said sensor. The electronic device 10 comprises a trim element acting as a case back 7 and capable of being mounted removably on the case 5 of the wristwatch 1, here by screwing. As may be seen in the illustration of FIG. 2, the electronic module 10A is integrally housed within said trim element acting as case back 7. Reference numeral 70 in FIG. 2 denotes an optional element of the electronic device 10 according to the invention, namely a partitioning element 70 which is advantageously interposed between the electronic module 10A and the horological movement M. This partitioning element 70 may, if necessary, act as a shielding element for reducing any interference of the electronic module 10A with operation of the horological movement M.

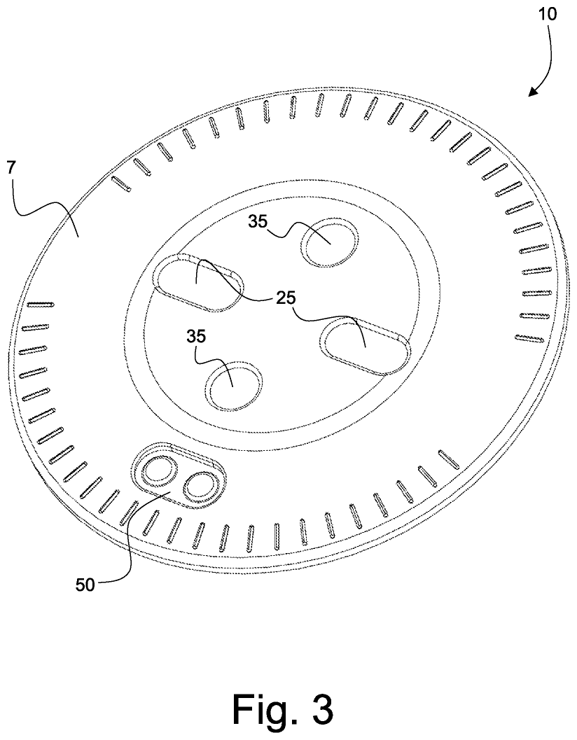

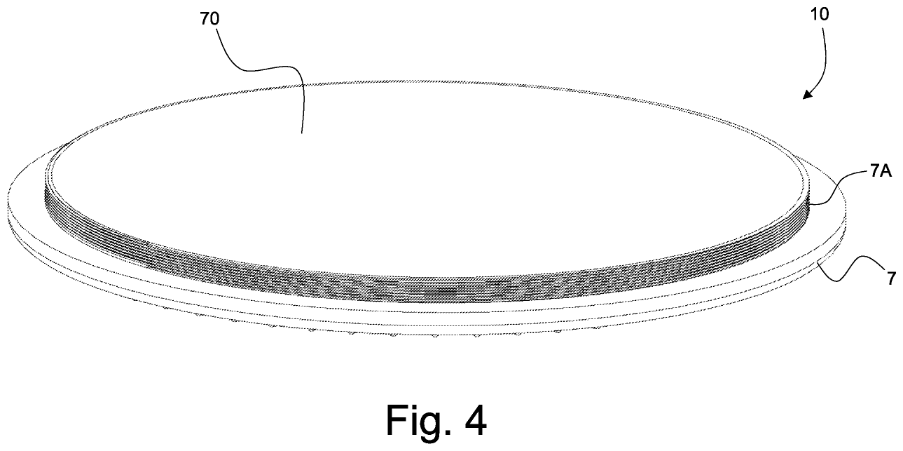

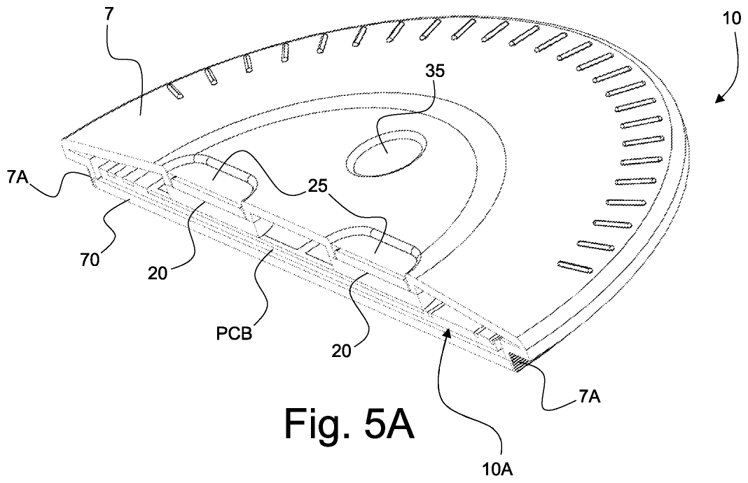

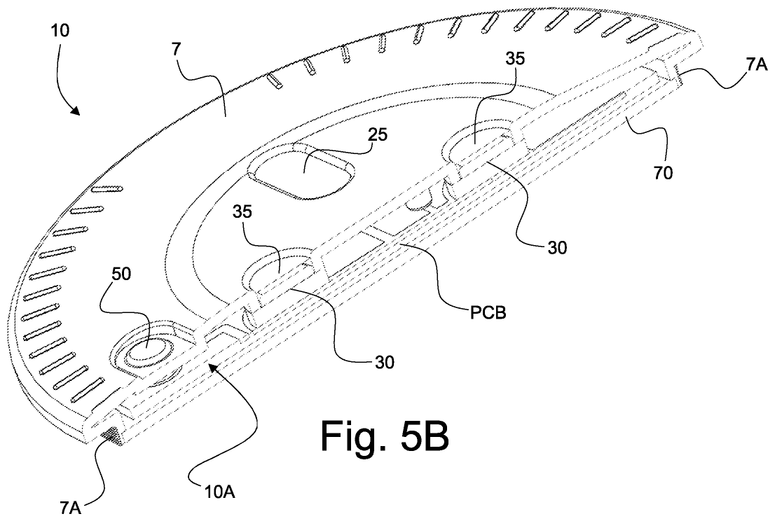

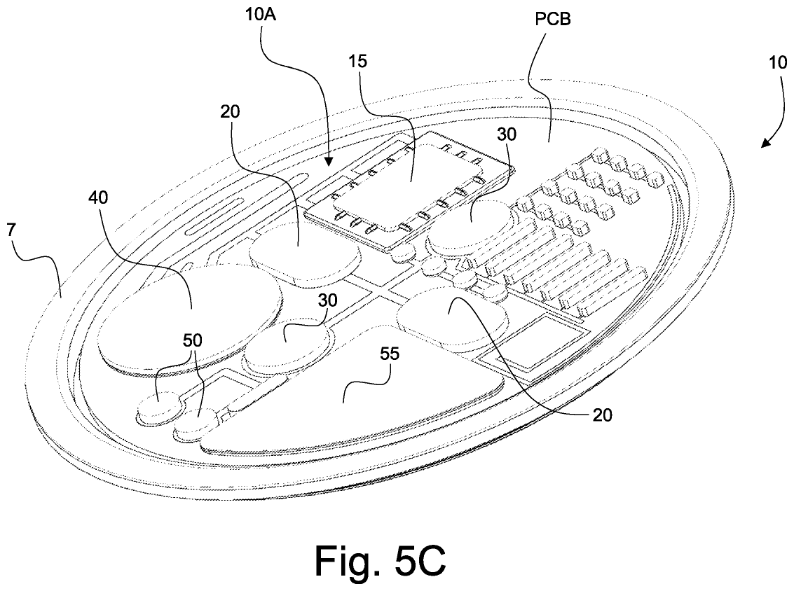

FIGS. 3 to 5A-C illustrate the electronic device 10, shown separately, disassembled from the wristwatch 1 of FIGS. 1 and 2. FIGS. 3 and 4 show, respectively, the wrist side and the movement side of the electronic device 10. In FIG. 4, one may see amongst other things the aforementioned partitioning element 70, which is optional, and securing means 7A for securement of the trim element acting as case back 7, here taking the form of a threading configured to interact with a corresponding tapped threading formed on the inner portion of the case 5 (which elements 70, 7A are also visible in the sectional views of FIGS. 5A and 5B). In FIG. 3, one may see a first set of two windows 25 of oblong shape and a second set of two windows 35 of circular shape, along with a connector 50, formed in the outer face that is intended to come into contact with the wearer's wrist, all belonging to the trim element acting as case back 7, the purpose of which will become more apparent hereafter.

FIG. 5A is a perspective view of a transversal cross-section through the electronic device 10 of FIG. 3, taken along a vertical sectional plane passing through the 9 o'clock-3 o'clock axis of the electronic device 10, through the first set of windows 25. FIG. 5A shows a portion of the electronic module 10A housed inside the trim element acting as case back 7, and more particularly a set of two sensors, denoted by reference numeral 20, positioned facing the two windows 25. Here, these sensors 20 are optical sensors (such as light-sensitive photodiodes) for the optical measurement of the heart rate.

FIG. 5B is a perspective view of a longitudinal cross-section through the electronic device 10 of FIG. 3, taken along a vertical sectional plane passing through the 12 o'clock-6 o'clock axis of the electronic device 10, through the second set of windows 35. FIG. 5B shows another portion of the electronic module 10A housed inside the trim element acting as case back 7, and more particularly a set of two light sources, denoted by reference numeral 30, placed facing the two windows 35 and associated with the aforementioned optical sensors 20. These light sources 30 are advantageously light-emitting diodes (LEDs), particularly LEDs producing a green light emission which is absorbed in a variable way depending on the blood flow circulating at the surface of the wearer's wrist where the wristwatch 1 is worn.

The assembly consisting of the optical sensors 20, the light sources 30, and the associated electronic control unit operates according to a principle that is well-known in itself, in order to proceed to a determination of the wearer's heart rate and potentially its variation over time.

FIG. 5C is a partial perspective view of the electronic device 10 of FIG. 3, part of the trim element acting as case back 7 being omitted in order to reveal the electronic module 10A housed thereinside. Visible in FIG. 5C are the aforementioned two sensors 20 and two light sources 30, the associated electronic control unit 15, the connector 50, a rechargeable battery 55 that can be recharged by means of an external charger linked to the connector 50, and an additional sensor 40 capable of detecting an action of the wearer on the wristwatch 1 when the latter is worn on the wrist. These components 20, 30, 40, 55 of the electronic module 10A are advantageously mounted on a single printed circuit board, denoted by the abbreviation PCB in FIGS. 5A-C.

Here, the additional sensor 40 is advantageously coupled to the trim element acting as case back 7, and may in particular consist of a force or pressure sensor. It may particularly be a piezoelectric sensor capable of detecting a pressure or deformation applied to the outer face of the trim element acting as case back 7. Accordingly, the additional sensor 40 makes it possible to detect a strain transmitted to the trim element acting as case back 7, once the wristwatch 1 is worn on the wrist, in reaction to a pressure applied by the wearer to a front part of the wristwatch 1, such as an action of the wearer on the glass 2 or the bezel 3.

The electronic module 10A also advantageously comprises a wireless communication unit, particularly a communication unit operating according to the Bluetooth standard (IEEE 802.15.1), capable of communicating wirelessly with a third-party electronic device, such as a smartphone.

The electronic module 10A could comprise other components and sensors, such as an accelerometer, an audible or vibrating warning device, etc.

By way of additional, particularly advantageous functionality, one may in particular envisage that the electronic device according to the invention could implement a tracking and geolocating function of the electronic device (and therefore of the wristwatch fitted with the electronic device). This functionality may, in particular, be based on the so-called “Find My Device” functionality, which is conventionally used for tracking and geolocating smartphones or other connected devices. An example of a tracking application is, for example, the Prey application (https://preyproject.com), which is available in open source and can be implemented in the electronic device according to the invention for the purpose of easily retrieving the electronic device along with the associated wristwatch in case of loss or theft.

The trim element acting as case back 7 may in particular be made of the same material as the case 5 of the wristwatch 1. In that regard, the material may be a noble metal, such as a platinum or gold alloy, or any other metallic material, such as steel or titanium. Evidently, this list of materials is purely illustrative and does not limit the scope of the invention in any way.

It is to be understood that various modifications and/or improvements that are obvious to those skilled in the art may be made to the embodiments described in the present description, without departing from the scope of the invention as defined by the appended claims.

For example, the connector used for the connection to an external battery charger could, if appropriate, be omitted and replaced by a winding for recharging the battery in an inductive manner, provided that this does not interfere with proper operation of the horological movement.

It is also to be understood that the method of securing the trim element acting as case back could be other than screwing, and will essentially depend on the solution originally adopted for securing the ordinary case back to the wristwatch case, as specified by the manufacturer who produced the wristwatch that is to be fitted with the electronic device according to the invention. In this respect, the trim element acting as case back may itself be provided with securing means for securement to the case, as illustrated, or may be secured to the case by other means, such as a set of screws.

It is also to be understood that the particular shape and arrangement of the windows formed in the outer face of the trim element acting as case back are not limiting.

### LIST OF REFERENCE SIGNS USED IN THE PRESENT DESCRIPTION AND IN THE DRAWINGS

1 wristwatch
2 glass
3 bezel
4 analog time display mechanism (e.g. hands)
5 watch case
6 dial
7 trim element acting as case back
7A securing means for securement of trim element acting as case back 7 to watch case 5 (for example by screwing)
10 electronic device
10A electronic module
15 electronic control unit
20 sensors of physiological data of the wearer/optical heart rate sensors
25 (first) windows associated with sensors 20
30 light sources/light-emitting diodes
35 (second) windows associated with light sources 30
40 additional sensor for detecting an action by the wearer/force or pressure sensor
50 connector for recharging of battery 55
55 rechargeable battery
70 partitioning element interposed between electronic module 10A and horological movement M
M horological movement
PCB printed circuit board carrying in particular components 20, 30, 40, 50 and 55

1.-21. (canceled)

22. An electronic device for a wristwatch comprising an electronic module provided with at least one sensor capable of measuring physiological data of a wearer of the wristwatch and with an electronic control unit associated with the sensor,
wherein the electronic device comprises a trim element acting as a case back and capable of being mounted removably on a case of the wristwatch,
and wherein the electronic module is integrally housed within the trim element acting as case back.

23. The electronic device according to claim 22, wherein the trim element acting as case back comprises securing means for securement to the case of the wristwatch.

24. The electronic device according to claim 23, wherein the trim element acting as case back takes the form of a case back that can be screwed onto the case of the wristwatch.

25. The electronic device according to claim 22, wherein the sensor capable of measuring physiological data of the wearer of the wristwatch is an optical heart rate sensor,
and wherein the trim element acting as case back is provided, on an outer face intended to be positioned in contact with the wearer's wrist, with at least a first window positioned facing the optical heart rate sensor.

26. The electronic device according to claim 25, wherein the optical heart rate sensor is a light-sensitive photodiode.

27. The electronic device according to claim 25, wherein the electronic module further comprises at least one light source associated with the optical heart rate sensor,
and wherein the trim element acting as case back is provided, on its outer face, with at least a second window positioned facing the light source.

28. The electronic device according to claim 27, wherein the light source is a light-emitting diode.

29. An electronic device for a wristwatch comprising an electronic module provided with at least one sensor capable of measuring physiological data of a wearer of the wristwatch and with an electronic control unit associated with the sensor,
wherein the electronic device comprises a trim element acting as a case back and capable of being mounted removably on a case of the wristwatch,
wherein the electronic module is integrally housed within the trim element acting as case back,
wherein the sensor capable of measuring physiological data of the wearer of the wristwatch comprises a set of two optical heart rate sensors,
wherein the trim element acting as case back is provided, on an outer face intended to be positioned in contact with the wearer's wrist, with a pair of first windows positioned facing the set of two optical heart rate sensors,
wherein the electronic module further comprises a set of two light sources associated with the set of two optical heart rate sensors,
and wherein the trim element acting as case back is further provided, on its outer face, with a pair of second windows positioned facing the set of two light sources.

30. The electronic device according to claim 29, wherein each optical heart rate sensor is a light-sensitive photodiode,
and wherein each light source is a light-emitting diode.

31. The electronic device according to claim 22, wherein the electronic module further comprises a wireless communication unit capable of communicating wirelessly with a third-party electronic device, such as a smartphone.

32. The electronic device according to claim 31, wherein the wireless communication unit is a communication unit operating according to the Bluetooth standard.

33. The electronic device according to claim 29, wherein the electronic module further comprises an additional sensor capable of detecting an action by the wearer on the wristwatch when the latter is worn on the wrist.

34. The electronic device according to claim 29, wherein the electronic module further comprises an additional sensor capable of detecting an action by the wearer on the wristwatch when the latter is worn on the wrist.

35. An electronic device for a wristwatch comprising an electronic module provided with at least one sensor capable of measuring physiological data of a wearer of the wristwatch and with an electronic control unit associated with the sensor,
wherein the electronic device comprises a trim element acting as a case back and capable of being mounted removably on a case of the wristwatch,
wherein the electronic module is integrally housed within the trim element acting as case back,
wherein the electronic module further comprises an additional sensor capable of detecting an action by the wearer on the wristwatch when the latter is worn on the wrist,
and wherein the additional sensor is a sensor coupled to the trim element acting as case back in order to detect a strain transmitted to the trim element acting as case back in reaction to a pressure applied by the wearer to a front part of the wristwatch.

36. The electronic device according to claim 35, wherein the additional sensor is capable of detecting a strain applied by the wearer to a glass or bezel of the wristwatch.

37. The electronic device according to claim 35, wherein the additional sensor is a force or pressure sensor.

38. The electronic device according to claim 35, wherein the electronic module further comprises a battery.

39. The electronic device according to claim 38, wherein the battery is a rechargeable battery.

40. The electronic device according to claim 39, wherein the electronic device further comprises a connector for providing an electrical connection to an external charger device for recharging the battery.

41. The electronic device according to claim 35, wherein all of the electronic components of the electronic module are mounted on a single printed circuit board.

42. An electronic device for a wristwatch comprising an electronic module provided with at least one sensor capable of measuring physiological data of a wearer of the wristwatch and with an electronic control unit associated with the sensor,
wherein the electronic device comprises a trim element acting as a case back and capable of being mounted removably on a case of the wristwatch,
wherein the electronic module is integrally housed within the trim element acting as case back,
and wherein the electronic device further comprises a partitioning element arranged so as to be interposed between the electronic module and a horological movement housed within the case of the wristwatch once the trim element acting as case back is mounted on the case.

43. The electronic device according to claim 42, wherein the partitioning element acts as a shielding element for reducing any interference of the electronic module with operation of the horological movement.

44. The electronic device according to claim 22, wherein the electronic device further implements a tracking and geolocating function, enabling the electronic device to be retrieved in case of loss or theft.

45. A wristwatch comprising a case including a removable case back and a horological movement housed within the case,
and wherein the removable case back consists of an electronic device according to claim 22.

46. A wristwatch comprising a case including a removable case back and a horological movement housed within the case,
and wherein the removable case back consists of an electronic device according to claim 29.

47. A wristwatch comprising a case including a removable case back and a horological movement housed within the case,
and wherein the removable case back consists of an electronic device according to claim 35.

48. A wristwatch comprising a case including a removable case back and a horological movement housed within the case,
and wherein the removable case back consists of an electronic device according to claim 42.
